(19) United States
(12) Patent Application Publication
(10) Pub. No.: US 2020/0077506 A1
(43) Pub. Date: Mar. 5, 2020

(54) COMPACT SOLID TARGET FOR LOW ENERGY MEDICAL CYCLOTRON

(71) Applicant: Memorial Sloan Kettering Cancer Center, New York, NY (US)

(72) Inventors: Yiauchung SHEH, New York, NY (US); Gregory AYZENBERG, New York, NY (US)

(21) Appl. No.: 16/467,856

(22) PCT Filed: Dec. 5, 2017
(86) PCT No.: PCT/US2017/006470

§ 371 Date: Jun. 7, 2019

Related U.S. Application Data
(60) Provisional application No. 62/431,547, filed on Dec. 8, 2016.

(51) Int. Cl. H05H 6/00; G21G 1/10

(52) U.S. Cl. CPC H05H 6/00; G21G 1/10

(57) ABSTRACT

Described herein is a compact cyclotron solid target for radionuclide production. In contrast to other cyclotron solid targets, the compact cyclotron solid target described herein utilizes liquid (e.g., water) cooling flow (in and out) from the front of the target, which clears the back of the solid target of any hanging tubing and connectors which may block load-release the target easily. Having water cool the target from the front considerably reduces the size of the whole solid target mechanism.

### CROSS REFERENCE TO RELATED APPLICATION

This application claims the benefit of U.S. Application Ser. No. 62/431,547 filed on Dec. 8, 2016, the disclosure of which is hereby incorporated by reference in its entirety.

### GOVERNMENT SUPPORT

This invention was made with government support under grant number CA008748 awarded by the National Institutes of Health. The government has certain rights in the invention.

### TECHNICAL FIELD

The invention relates generally to cyclotron targets for radionuclide production, and related systems and methods. More particularly, in certain embodiments, the invention relates to compact cyclotron solid targets for radionuclide production.

### BACKGROUND

Small-sized cyclotrons (E<20 MeV) are generally used for production of short-lived radionuclides useful in the operation of various medical imaging systems, for example, positron emission tomography (PET) systems. Medical cyclotrons typically accelerate two particles, i.e. protons and deuterons, and mostly produce positron emission radionuclide, for example, ¹¹C (T_{1/2}=20.4 min), ¹³N (T_{1/2}=10.0 min), ¹⁵O (T_{1/2}=2.05 min), and ¹⁸F (T_{1/2}=109.6 min). These emitters are easily produced via the low-energy (p,n), (p,α), (d,n) and (d,α) nuclear reactions. Generally, for the production of ¹¹C, ¹⁵O and ¹⁸F (electrophilic form), gas targets are used, and for the production of ¹³N and ¹⁸F (nucleophilic form) liquid targets (e.g., water) are used. Load-unload gas and liquid targets material can be easily accomplished through a tubing in-out of the target; however, solid targets have to be physically installed and unloaded. Therefore, most of the medical cyclotrons are equipped only with gaseous and liquid targets and are not compatible with solid targets. Additional background information on target development and cyclotrons is described, for example, by Spellerberg et al. in “Target development for diversified irradiations at a medical cyclotron” Applied Radiation and Isotopes 104 (2015) 106-112.

Individual institutions typically develop their own solid target with an external beamline to match their medical cyclotron. Development of a custom solid target with the external beamline typically requires sufficient space to house the beamline. This setup typically involves bending magnet(s), steering magnet(s), focusing magnet(s), a complete vacuum system on the target side which involves a target load-release mechanism, target water cooling, and close looped Helium cooling. Some beamline target systems may include a water cooled foil capability to reduce incident energy for a fixed energy cyclotron. In addition to using flat targets, some custom systems have a slanted target capability and operate at up to 25 μA on ¹²⁴I, for example. However, these custom systems require a large amount of space, high cost, and the solid target must be developed individually (i.e. not compatible with other custom systems).

Companies like ELEX and Alceo/Comecer have also developed solid target systems for IBA and GE Medical cyclotrons with short or no beamlines. These companies provide a solid target to a customer, thereby reducing the time and effort of the user and the cost to develop the target individually. Target capability of these systems may or may not have a beam line, and are compatible with flat targets only, and use less or much less than 25 μA on ¹²⁴I, for example. However, a flat target cannot withstand high current (i.e. the target can only be exposed to a medium or low current range), thereby reducing radionuclide yield.

Moreover, in contrast to dumping radioactive material from traditional gaseous and liquid targets, current solid targets on the market require larger spaces, more mechanistic systems such as solenoids and cylinders to hold and drop the target. While gaseous and liquid targets are easily moved to dumping stations and simply flow though tubing, solid targets are more challenging to be held and dumped due to their solid nature.

Thus, there remains a need for improved solid target medical cyclotrons for radionuclide production that eliminate space constraints, reduce cost, and feature improved target design for increased yield.

### SUMMARY

Described herein is a compact cyclotron solid target for radionuclide production. In contrast to other cyclotron solid targets, the compact cyclotron solid target described herein utilizes liquid (e.g., water) cooling flow (in and out) from the front of the target, which clears the back of the solid target of any hanging tubing and connectors which may block load-release the target easily. Having water cool the target from the front considerably reduces the size of the whole solid target mechanism. Notably, in certain embodiments, this design brings the center of the slanted target head close to the front vacuum separation foil at about 1.86 inches away which matches the center of a cyclotron traditional target (¹⁸F, ¹¹C, ¹³N in gaseous or liquid form), and may fully utilizes beam properties designed for traditional target at cyclotron exit port. In addition, two designated Helium jets scrape through the target surface to provide target cooling for target materials of low thermal conductivity. Also, a water cooled front foil does not require extra effort for reducing target incident energy. This design can be easily integrated into a main stream medical cyclotron targetry, and eliminates the need for a beamline. This design also preserves the flexibility of solid target design for different isotope production by modifying target head and Helium jet accordingly.

In one aspect, the invention is directed to a solid target head for use in a compact cyclotron (e.g., a medical cyclotron for production of radionuclides used in a medical imaging system, e.g., a positron emission tomography (PET) imaging system), the solid target head comprising an elongated enclosure (e.g., wherein the elongated enclosure has an outer diameter within a range of from about 1.5 to about 3 inches (e.g., 1.75 inches) and a length within the range from about 2 to about 3 inches (e.g., 2.6 inches) for secure insertion of a foil (e.g., aluminum) held at a fixed angle with respect to a beam (e.g., a proton beam, e.g., a charged particle beam), the enclosure itself insertable and removable from a solid target chamber, wherein the elongated enclosure has a proximal (front) end and a distal (back) end, the enclosure having a cooling channel therethrough, the proximal end having both entry and exit openings for liquid coolant to flow through the cooling channel.

In certain embodiments, the distal (back) end of the elongated enclosure is sized and shaped to provide a seal with the solid target chamber and to permit slidable insertion and removal of the solid target head from the solid target chamber.

In certain embodiments, the fixed angle is slanted from 10 to 20 degrees with respect to the beam.

In certain embodiments, the solid target head is removable from the solid target chamber by application of pressure via liquid coolant flowing through the cooling channel.

In another aspect, the invention is directed to a solid target chamber comprising: (i) a target chamber for releasably securing the solid target head, (ii) a target cooling adapter for mounting a vacuum separation foil (e.g., aluminum foil), a liquid coolant (e.g., water) line input and output, a gas coolant (e.g., He) input and output (e.g., wherein the target chamber and the target cooling adapter together have an outer diameter within a range from about 2.5 to about-4 inches (e.g., 3.1 inches) and a length within a range from about 3 to about 4 inches (e.g., 3.3 inches)), and, (iii) optionally, a vacuum adapter through which the beam (e.g., the proton beam) travels from cyclotron into the solid target head (e.g., wherein size of the vacuum adapter depends on the cyclotron).

In another aspect, the invention is directed to a compact solid target comprising: (i) a solid target head, and (ii) a solid target chamber.

Elements of embodiments involving one aspect of the invention (e.g., methods) can be applied in embodiments involving other aspects of the invention, and vice versa.

### Definitions

In order for the present disclosure to be more readily understood, certain terms are first defined below. Additional definitions for the following terms and other terms are set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art.

“Substantially”: As used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

The term “front” as described herein is referred to the position with respect to entrance of the beam.

Drawings are presented herein for illustration purposes, not for limitation.

### BRIEF DESCRIPTION OF DRAWINGS

The foregoing and other objects, aspects, features, and advantages of the present disclosure will become more apparent and better understood by referring to the following description taken in conduction with the accompanying drawings, in which:

FIG. 1 shows an assembled low energy compact cyclotron solid target, according to an illustrative embodiment.

FIGS. 2A-2C and FIG. 6 are the two exit ports of MSKCC cyclotron at CBIC (Citigroup Biomedical Imaging Center). The cyclotron was made by Advanced Cyclotron System, model TR19/9 variable energy. It has 2 beam exit ports. All test trials in this report were performed at this cyclotron.

FIGS. 2A-2C shows a fully equipped beamline for conventional medical cyclotron The proton beam travels horizontally out of cyclotron exit port-1 via a bending magnet (blocked by shielding), a steering magnet (blocked by shielding), and a focusing magnet toward target station. The target station has 6 target positions available. Solid target (developed 1993, ref http://www.sciencedirect.com/science/article/pii/0168583X94007624) was mounted at the end slot. Noted this target design, all cooling and control are in and out from behind the target head. To load the target head, the target was rotated to the side-mount target head and the target was rotated to the center line. The target then engaged with the station adaptor and was ready for bombardment. To drop the target head, cooling is stopped, and the target was disengaged from station adapter. The target is rotated to the side line up with receiving tube and the target head is unlocked. The air to water line was compressed to push the target head into tube and the target head was retrieved in the lead pig.

FIG. 6 shows a side view of the conventional target (¹⁸F, ¹¹C, ¹³N in gaseous or liquid form), at exit port-2, MSKCC cyclotron at CBIC. The cyclotron has a self-shielded side, and is a target station with 4 positions available confined into 16 inch cubic when shielding closed. The provided compact solid target was mounted on position-C. To load the target head, the locking pins are first released, then the solid target head is plugged in, then the locking pin was activated. Next the target is prepared, cooled, and is ready for bombardment. To drop the target head, the water is vented, and helium is released remotely via the locking pin. The target head can either shoot out from back of target chamber and catch by a net or can be pulled by hand (easier and faster less 3˜5 sec) into lead pig and carried to lab.

The provided compact cyclotron solid target runs occasionally in the MSKCC facility since there is a running beamline solid target and it is challenging to open and close two ton shielding doors for each load-unload solid target head. Cyclotron manufacturers can easily adopt this target design and integrate the design into their standard target package. With their manufacturing capability, it is easier for them to rearrange the shielding for install and drop the solid target easily.

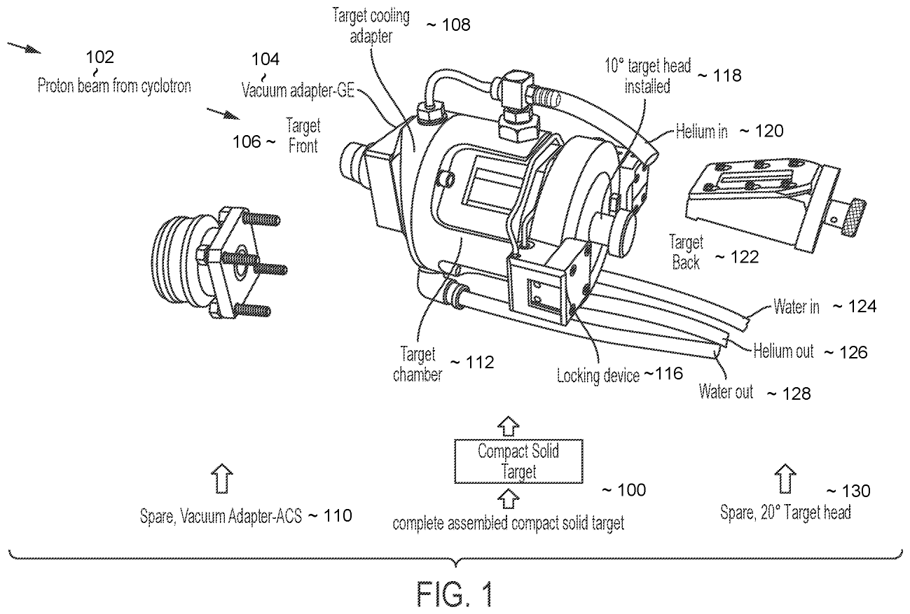

FIGS. 3-5 show a disassembled compact solid target shown in FIG. 1.

FIGS. 7A-7C show the front (FIG. 7A) and back (FIG. 7B) of a target ⁸⁶Y foil after 17.5 μA×3 hr bombardment on beamline 10° solid target, according to an illustrative embodiment of the invention. FIG. 7C shows a newly built I¹²⁴ target. ¹²⁴TeO₂ is melted on platinum backing. It is about 0.003 inches thick and is ready to mount on beamline 20° solid target for bombardment.

FIG. 8 shows a schematic of a proton beam has been defused bigger than the target area, according to an illustrative embodiment of the invention.

### DETAILED DESCRIPTION

Throughout the description, where compositions are described as having, including, or comprising specific components, or where methods are described as having, including, or comprising specific steps, it is contemplated that, additionally, there are compositions of the present invention that consist essentially of, or consist of, the recited components, and that there are methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Described herein is a compact cyclotron solid target for radionuclide production. In contrast to other cyclotron solid targets, the compact cyclotron solid target described herein utilizes liquid (e.g., water) cooling flow in-out from the front of the target which clears the back of the solid target of any hanging tubing and connectors which may block load-release the target easily. Having water cool the target from the front considerably reduces the size of the whole solid target mechanism.

Notably, this design brings the center of the slanted solid target head close to the front vacuum separation foil at about 1.86 inches away which matches the center of a cyclotron traditional target (¹⁸F, ¹¹C, ¹³N in gaseous or liquid form), and may fully utilizes beam properties designed for traditional target at cyclotron exit port. In addition, two designated Helium jets scrape through the target surface to provide target cooling for target materials of low thermal conductivity. Also, a water cooled front foil does not require extra effort for reducing target incident energy. This design can be easily integrated into a main stream medical cyclotron targetry, and eliminates the need for a beamline. This design also preserves the flexibility of solid target design for different isotope production by modifying target head and Helium jet accordingly.

Moreover, in contrast to conventional systems, the compact cyclotron solid target described herein simply uses 2 pins to hold the target in place. The pin-lock feature reduces the size of the solid target dramatically. Moreover, benefits of a reduced target size can enable a standardized solid target design as a part of a cyclotron package by cyclotron manufacturers as a tool for radioisotope production from solid targets.

In certain embodiments, water cooled front foil allows energy degradation for a fixed energy cyclotron (e.g., from 18 MeV to 15 MeV). In certain embodiments, angled targetry (e.g., 10°, e.g., 20°) allow more efficient heat transfer capable of high current, for example, greater than or equal to 40 μA on ¹²⁴I. In contrast, conventional cyclotron solid targets are limited to current up to 25 μA on ¹²⁴I. Moreover, in certain embodiments, target release can be automated to reduce personnel radiation exposure.

Target yield depends on various factors, including, type of target material (e.g., properties of the material such as heat conductivity), energy (MeV) coming in and out of target material (e.g., which part of production cross section is intended for use), how much μA can be applied to the target, and how much time is required to bombard the target.

### Example: Device and Device Operation

Target performance was compared using the same isotope across cyclotrons to see what μA the target can be exposed to without melting the target. The yield produced from each process was used as a reference and compared to assess performance (see Table 1).

As described herein, the compact solid target features water cooling coming from the front. Angled targetry, a water-cooled front foil, and, in certain embodiments, Helium cooling enable the solid target to accept much higher energy dump, thereby generating a high isotope yield.

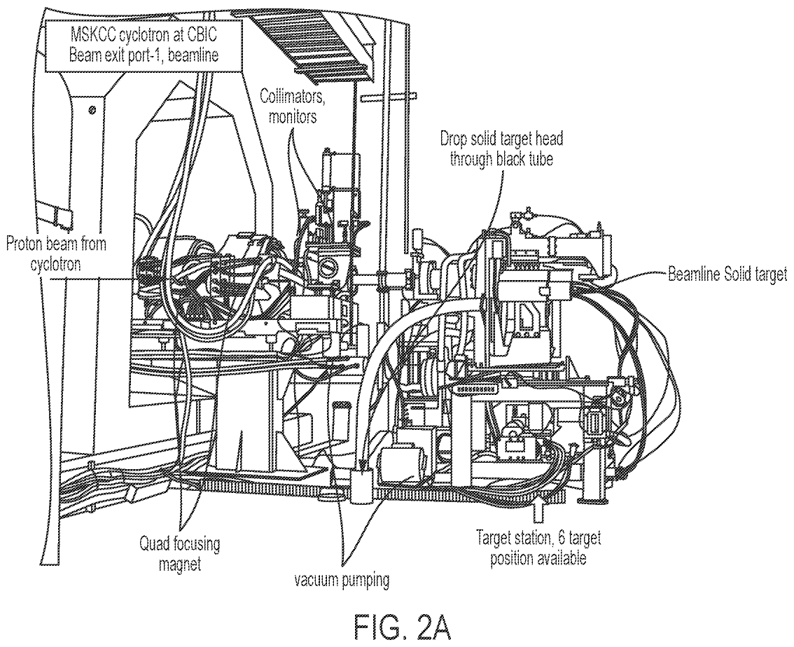

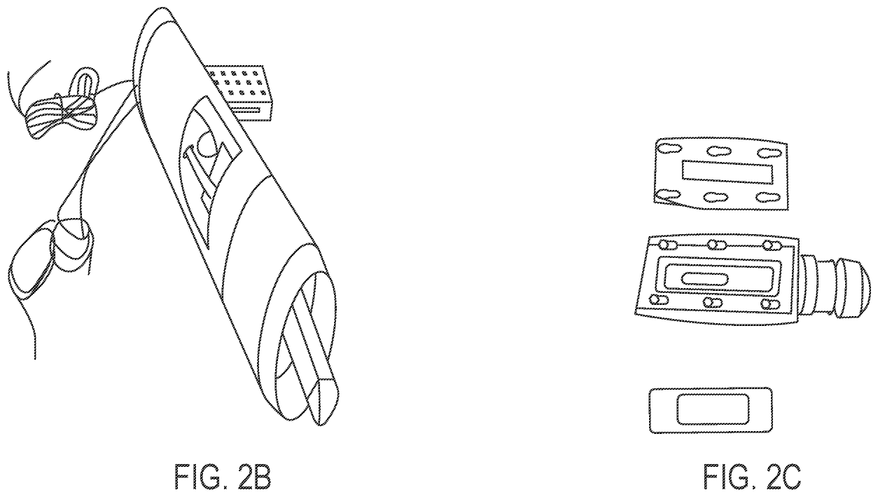

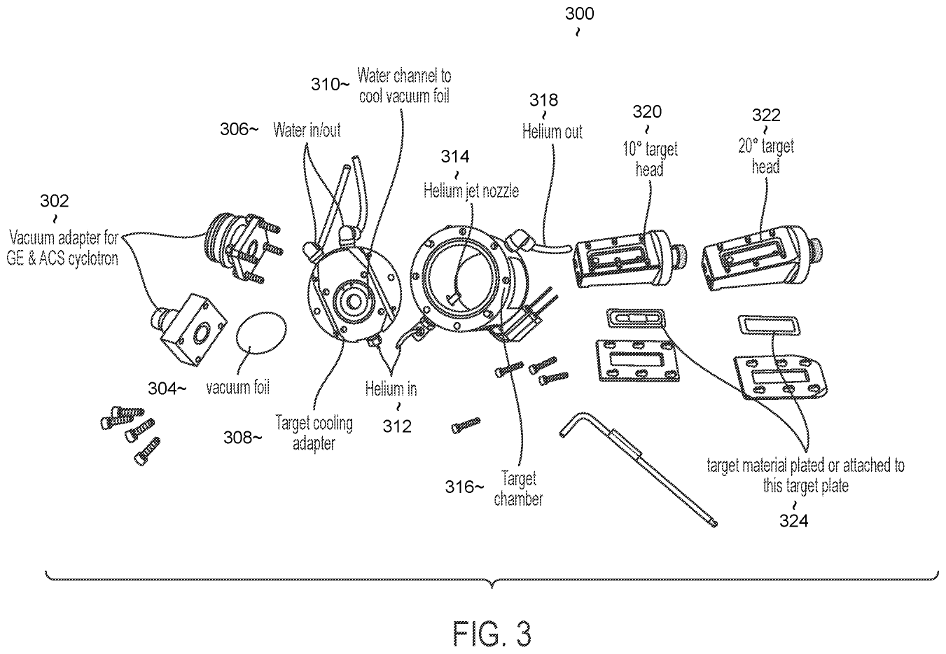

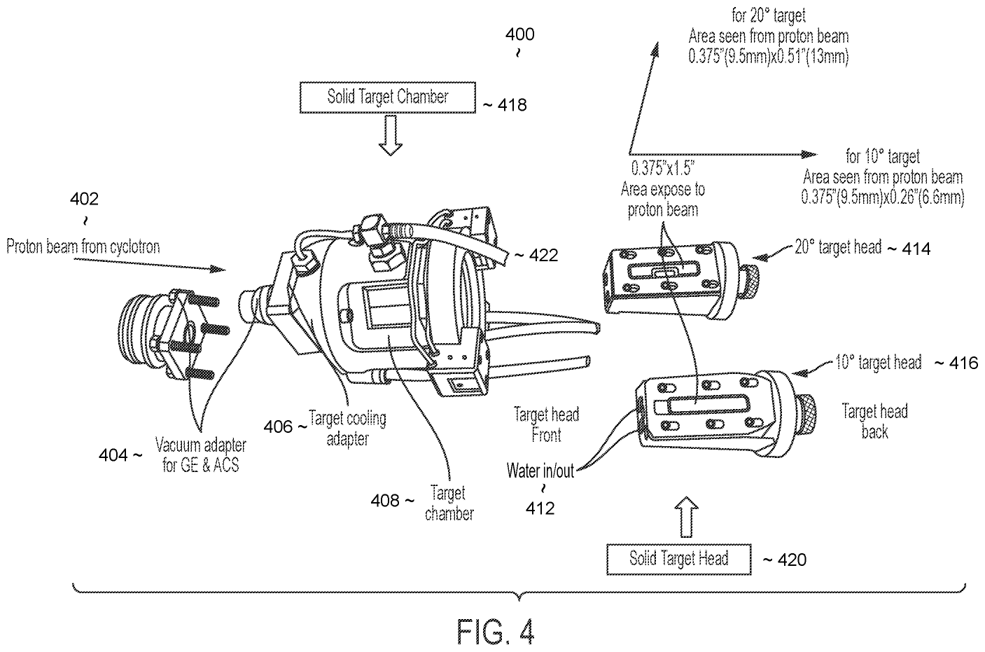

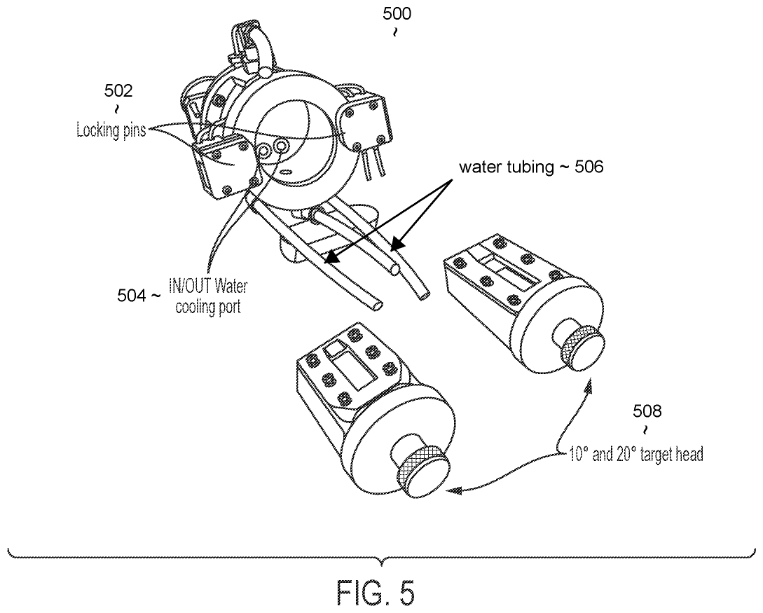

FIG. 1 shows an assembled low energy compact cyclotron solid target 100, according to an illustrative embodiment. Low energy compact cyclotron solid target 100 includes vacuum adapter 104, target cooling adapter 108, a 10° target head 118, and locking device 116. Helium is introduced via helium inlet 120 and helium outlet 126, and cooling water is introduced via water inlet 124 and water outlet 128. Low energy compact cyclotron solid target 100 also includes a spare vacuum adapter 110 and a spare 20° target head 130. A proton beam 102 travels through the target front 106 and hits a target in target chamber 112. Radionuclides produced from the collision of proton beam 102 with the target can then exit low energy compact cyclotron solid target 100 through target back 122. Notably, FIG. 1 is much smaller than conventional cyclotrons (FIGS. 2A-2C).

FIG. 3 shows a disassembled compact solid target 300 shown in FIG. 1. The compact solid target eliminates space constraints required by conventional systems, reduces cost of the beam line, and maintains yield.

FIG. 3 shows (from left) two vacuum adapters 302 (one for an ACS cyclotron and one for a cyclotron), a round aluminum foil mount 304 in between vacuum adapter target cooling adapter 308. The target cooling adapter 308 has two o-rings where the aluminum 304 is mounted to form a cooling water channel 310 for the foil 304. The aluminum separates a cyclotron vacuum and the target. The targeting cooling adapter 308 has two holes for water to come in and out (water in/out 306) and cool the target from the front. In certain embodiments, the aluminum foil is cooled by Helium via helium inlet 312. In certain embodiments, the aluminum foil is cooled by water (rather than Helium). In certain embodiments, the aluminum foil is cooled by water and Helium. FIG. 3 also shows a target chamber 316 comprising a Helium jet nozzle 314 and tubing for Helium out 318. FIG. 3 also shows two target holders 324 (one for 10° target head 320 and one for 20° target head 322). In the middle of the left of the two holders is a blank aluminum target base. In the middle of the right of the two holders is a tellurium target.

Standard target materials are in the shape of a circularized disk. In contrast, the target material is shaped to be a rectangle. For example, the target can be 1.75 inches length and 0.5 inch wide (e.g., or a little less). The left bottom of the target cooling adapter is where Helium comes in and out. This design provides the option for Helium cooling for certain targets. In certain embodiments, the target material is melted as a thin glass on platinum base, and Helium cooling is required to prevent melting of material. Helium cooling is especially important for low thermo conductive target material. Melting can shorten target life.

ACS cyclotrons have variable energy (e.g., 13 MeV to 18 MeV). To manufacture an isotope, it's important to control energy (e.g., so that it is fixed). Otherwise, a change in energy can generate a distinct (e.g., undesired) isotope. For example, ¹²⁴I requires 13 MeV to generate impurity that is less than 1%. However, if 15 MeV is used, a radioisotope having about 10% impurity is generated and cannot be used. Changes in energy also affect yield (see Table 1).

Cyclotrons that use round targets use vertical bombardment, which limits the power that can be delivered to the target. In contrast, the disclosed cyclotron features a slanted target. For example, the target can be slated at 10 or 20 degrees. The area comparison between flat vs 10° is 1:5.8 and 20° is 1:3. The design of the disclosed compact cyclotron solid target enables heat to spread out through target, thereby allowing the target to cool faster. The design of the disclosed compact cyclotron also allows a user to bombard the target with higher current and obtain a higher yield in a shortened amount time compared to conventional cyclotrons. For example, a user can bombard 3-4 hours using the provided compact cyclotron solid target instead of 8 hours or more using convention cyclotrons solid target to produce a needed amount of isotope.

Furthermore, cooling from the back side of the target (in contrast to the front as described herein) requires much more mechanism to release the target. In contrast, cooling from the front side of the target allows easy removal of target through applying pressure to the target via the water line.

FIG. 4 shows disassembled compact solid target 400 that includes a solid target chamber 418 and solid target heads 420 as provided herein where particle beam 402 would be coming from the left. FIG. 5 shows a compact solid target 500 from a rotated perspective. From the left of FIG. 4, the first piece is a vacuum adapter 404. The vacuum adapter may vary in size, shape and mounting, depending on which brand cyclotron is used. Tubing 422 on the top of the aluminum housing is Helium cooling (in) where two copper tubes are pointed down going down on center of target. The target cooling adapter 406 on the left piece of the aluminum target chamber is used to cool the front foil and provide cooling to target head 414 or 416. Helium tubing 422 connects the front of the housing, with ⅛ tubing going into the target cooling adapter, where the front foil sits. This is to provide helium cooling to the center of front foil which proton beam 402 go through. Further, the front foil separates the vacuum between cyclotron and compact solid target in target chamber 408. In certain embodiments, a target can be slanted at 10 degrees or at 20 degrees, for example, using the 10° and 20° target heads 508 shown in FIG. 5. The compact solid target can be inserted into a cyclotron exit port easily, and water goes in from the front of the target head via water in/out 412.

FIG. 5 shows tubing water lines 506. For example, water cooling from the front only requires two locking pins 502 to hold target in place (back). When pin(s) 502 are engaged, water goes through solid target head securely via water cooling port 504. When the pins are released, air may be sent out through the water line, and the entire solid target head (whole metal piece) pops out. This design provides for a smaller cyclotron that allows for easy target removal and dumping.

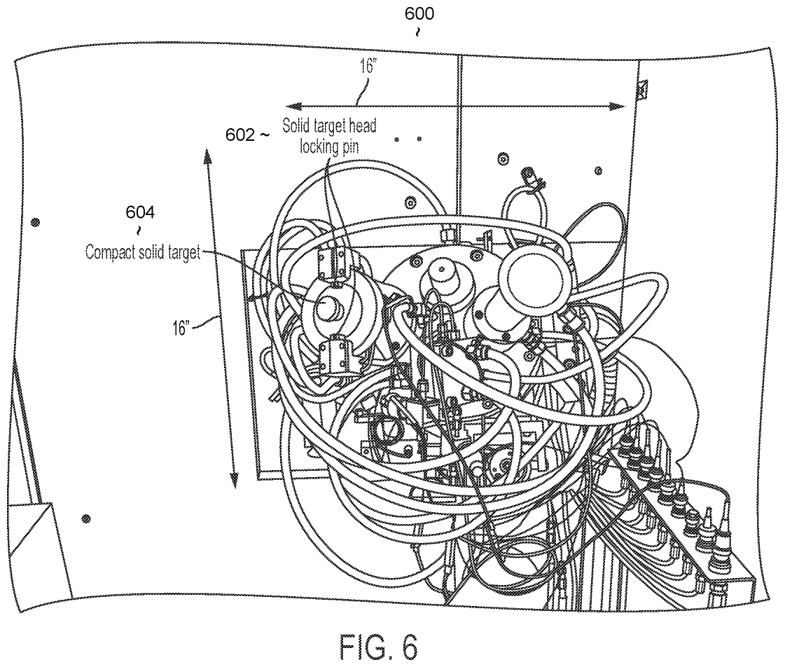

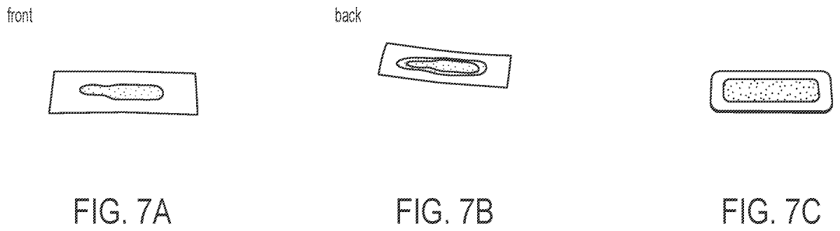

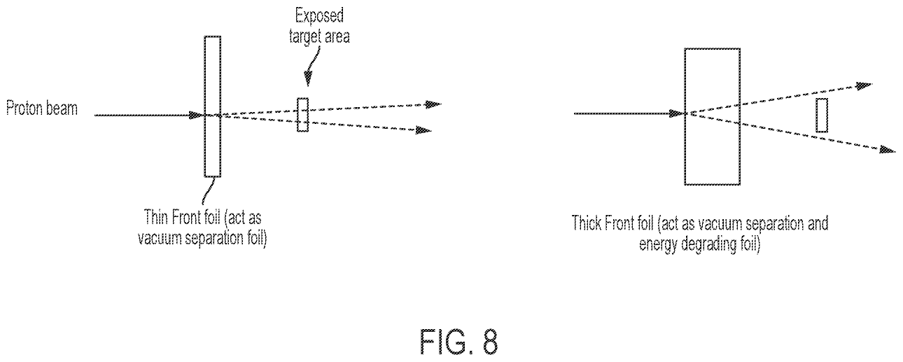

FIG. 6 shows a compact cyclotron target 604 in a machine 600 without the need for a beam line. FIG. 6 shows a side view of the conventional target (¹⁸F, ¹¹C, ¹³N in gaseous or liquid form), at exit port-2, MSKCC cyclotron at CBIC. This system is a self-shielded side, and is a target station with 4 positions available that are confined into a 16 inch cubic space when shielding is closed. The provided compact solid target was mounted on position-C. To load the solid target head, first release the locking pin 602 then plug in solid target head. Next, activate the locking pin 602 to secure the target head in position. Next, the target is ready for bombardment. To drop the solid target head, vent water and helium remotely, release locking pin to release solid target head (e.g., either let target head shoot out from back of target chamber and catch by a net or pull by hand (easier and faster by 3-sec)).

The provided compact solid target runs occasionally in MSKCC facility since there is a running beamline solid target and it is challenging to open and close 2 ton shielding for each load-unload target head). Cyclotron manufacturers can easily adopt this solid target design and integrate the design into their standard target package. With their manufacturing capability, it is easier for them to rearrange the shielding to install and drop the solid target easily.

### Cyclotron

MSKCC cyclotron at CBIC was made by Advanced Cyclotron System, model TR19/9 (18 MeV proton) with 2 beam exit ports. Port-1 is a full scaled beamline setup and target station that is custom modified/supported by MSKCC. This target station has 6 target positions available. Port-2 is a self-shield conventional target (¹⁸F, ¹¹C, ¹³N) side, with 4 target positions available.

### Tested Solid Target

The provided compact solid target 100 shown in FIG. 1 was mounted on conventional target side shown in FIG. 6. The provided compact solid target utilizes the same water & helium cooling provided to traditional target (¹⁸F, ¹¹C, ¹³N) by manufacturer. The provided compact solid target has water cooling 0.5 gal/min, and Helium cooling 75 L/min.

### Set Standard Yield for Comparison

The standard yield is the yield that is routinely obtained from the MSKCC beamline solid target for the last few years. Beamline solid target shown below FIG. 2B, FIG. 2C was mounted on the end of target station, position #6. It has water cooling 0.6 gal/min, and Helium cooling 180 L/min.

⁸⁹Zr, Reaction ⁸⁹Y(p,n)⁸⁹Zr, Proton-15 MeV, 18˜20 mCi@EOB+16 hr

The measure of the target foil was performed directly without extraction. The target material was a ⁸⁹Y foil with a thickness of 0.004 inches, and was mounted on 10° solid target. Bombardment was 17.5 μAhr. A typical view of front and back of the target foil after 17.5 μA×3 hr bombardment on beamline 10° solid target are shown in FIGS. 7A and 7B.

¹²⁴I, Reaction ¹²⁴I(p,n)¹²⁴Te, Proton-13 MeV, ˜5 mCi@EOB+24 hr

FIG. 7C shows a newly built I¹²⁴ target. ¹²⁴TeO₂ is melted on platinum backing and is about 0.003 inches thick. It's ready for mount on beamline 20° solid target for bombardment. As shown in Table 1, Yield of ¹²⁴I and ⁸⁹Zr from beamline solid target was used as a standard. ¹²⁴I is not an optimal target. For example, ¹²⁴I is derived from TeO₂ (which melts as glass). The heat conduction property of TeO₂ is poor. ⁸⁹Zr from ⁸⁹Y foil was attached to a blank aluminum plate and also possesses poor heat conductivity properties. Accordingly, cold Helium jet scraping coming from the front of the target plays a major role in cooling the target.

Table 1 shows 12 trials using the following reference standards: reference standard for trials 1 through 6, 9, and 12: ⁸⁹Zr, 10° target, beamline Zr⁸⁹_Cal. #517_18˜20 mCi_17.5 uAhr_@EOB++˜16 hr; and reference standard for trials 7, 8, 10 and 11: I¹²⁴, 20° target, beamline I¹²⁴_Cal. #570_5 mCi_25 uAhr_@EOB+24 hr.

TABLE 1

| | | Cyclotron setup | | | | | Measure- |
|---|---|---|---|---|---|---|---|
| | | Cyc_exit/ | | Target setup | | Bombard- | ment |
| | | on_target | Target | Target | He, Water | ment | amount |
| Trial | Isotope | MeV | foil | Angle | cooling | uA × hr | (mCi) |
| 1 | Zr⁸⁹ | 18 MeV/ | Al | 10° | He_751/min, | 17.5 × 1 | 12.2 |
| | | 15 MeV | 0.020″ | | water_0.5 Gal/min | | |
| 2 | Zr⁸⁹ | 18 MeV/ | Al | 10° | He_751/min, | 17.5 × 1 | 12.8 |
| | | 15 MeV | 0.020″ | | water_0.5 Gal/min | | |
| 3 | Zr⁸⁹ | 18 MeV/ | Al | 10° | He_751/min, | 25 × 1 | 18.1 |
| | | 15 MeV | 0.020″ | | water_0.5 Gal/min | | |
| 4 | Zr⁸⁹ | 15 MeV/ | Havar | 10° | He_751/min, | 17.5 × 1 | 20.2 |
| | | 15 MeV | 0.0005″ | | water_0.5 Gal/min | | |
| 5 | Zr⁸⁹ | 15 MeV/ | Havar | 10° | He_751/min, | 25 × 1 | 23.9 |
| | | 15 MeV | 0.0005″ | | water_0.5 Gal/min | | |
| 6 | Zr⁸⁹ | 15 MeV/ | Havar | 10° | He_751/min, | 30 × 1 | 31.1 |
| | | 15 MeV | 0.0005″ | | water_0.5 Gal/min | | |
| 7 | I¹²⁴ | 15 MeV/ | Havar | 10° | He_751/min, | 25 × 1 | 3.33 |
| | | 15 MeV | 0.0005″ | | water_0.5 Gal/min | | |
| 8 | I¹²⁴ | 15 MeV/ | Havar | 20° | He_751/min, | 25 × 1 | 6.06 |
| | | 15 MeV | 0.0005″ | | water_0.5 Gal/min | | |
| 9 | Zr⁸⁹ | 15 MeV/ | Havar | 20° | He_751/min, | 17.5 × 1 | 16.74 |
| | | 15 MeV | 0.0005″ | | water_0.5 Gal/min | | |
| 10 | I¹²⁴ | 15 MeV/ | Havar | 20° | He_751/min, | 35 × 1 | 9.48 |
| | | 15 MeV | 0.0005″ | | water_0.5 Gal/min | | |
| 11 | I¹²⁴ | 15 MeV/ | Havar | 20° | He_751/min, | 40 × 1 | 10.09 |
| | | 15 MeV | 0.0005″ | | water_0.5 Gal/min | | |
| 12 | Zr⁸⁹ | 15 MeV/ | Havar | 10° | He_751/min, | 35 × 1 | 36 |
| | | 15 MeV | 0.0005″ | | water_0.5 Gal/min | | |

Note:
Target materials ⁸⁶Y and ¹²⁴TeO₂ have low thermal conductivity.
Yield is proportional based on μA × Hr.
Signs of melting indicate that the maximum power applied to the target material has been reached.

Trial 1 and Trial 2 produced ⁸⁹Zr and intended to test out is any effect on yield due to energy degrading foil (see FIG. 4, FIG. 8). Trial 1 exhibited a 33% reduction in yield compared to the standard. Trial 2 was a repeat of Trial 1 and confirmed the 33% lower yield resulting from Trial 1. Without wishing to be bound by any theory, this result may be due to an Aluminum foil energy degrade and a diffused beam.

Trial 3 revealed that even if ⁸⁹Zr yield is about 33% lower than the standard yield, the beam current can be increased to get the same amount of radioactivity. The ability to increase the current for low thermo-conductive target materials is one of advantage of the provided target compared to convention targets. Trial 3 increased the beam current to 25-27 μA, and the yield was the same as the standard (19-20 mCi_17.5 μA 1 hr). In certain embodiments, increasing the area of the target (e.g., using a 20° target which has twice the target area exposed to the beam) can also be done to increase yield. However, using a 20° target changes the target thickness for the beam to go through. Accordingly, a thicker Yttrium target foil is needed (e.g., where a program like Srim simulation program can find the needed thickness).

Trial 4 also exhibited a ⁸⁹Zr yield that was equivalent to the standard. Trial 5 also exhibited a ⁸⁹Zr yield that was about 15% lower compared to the standard. Trial 6 also exhibited a ⁸⁹Zr yield that was about 10% lower compared to the standard. Trails 4, 5, and 6 maintain an increased beam current to obtain twice the yield within the same 1 hr bombardment as standard set as 17.5 μA×1 hr.

Trial 7 exhibited a 33% reduction in ¹²⁴I yield compared to standard. Trial 7 was performed without a thick front vacuum foil and with a diffused beam. Without wishing to be bound to any theory, this result may be due to the 10 degree angle, thereby causing the target to have a narrow cross area. The shape of the target was 5.5 mm×9.5 mm. Moreover, without wishing to be bound to any theory, the oblong shape of beam was bigger than the target area. The oblong shaped beam is known for the MSKCC cyclotron. Proton energy varies from 13 MeV to 18 MeV. Beam shape changes from round to oblong when the energy varies. This oblong beam does not affect beamline. Beamline has Quad focusing magnet. Refocus the beam to the size of pencil eraser.

Trial 8 exhibited ¹²⁴I yield higher than the standard and was a repeat of Trial 7. Trial 8 also confirmed that the low yield of Trial 7 was due to a narrow cross area by testing a 20 degree angle with a 10.9 mm×9.5 mm target (in contrast to the 10 degree angle and 5.5 mm×9.5 mm target tested in Trial 7).

Trial 9 exhibited a 15% reduction in ⁸⁹Zr yield compared to standard. The target was clean. Without wishing to be bound to any theory, the low yield may be due to a 0.004″ ⁸⁹Y foil bombarded at 10 degrees. Further, without wishing to be bound to any theory, a thicker foil for a 20° target as described in Trial 3 can be used.

Trial 10 and 11 make ¹²⁴I. Trial 10 performed equivalent or better than standard at 35 μA. No burn mark was shown on the target, which suggests that the beam current can be increased to about 40 μA. Trial 11 performed equivalent or better than standard at 40 μA. No burn mark was shown on the target, which suggests that the beam current can be increased to about 45 μA. Yield can double around 45-50 μA.

Trial 12 exhibited a 10% reduction in ⁸⁹Zr yield compared to the standard. The target reached 36 mCi at 35 μA. Without wishing to be bound to any theory, this may be due to a narrow cross area (5.5 mm×9.5 mm). Further, Trial 12 exhibited no sign of melting, suggested that a higher current can be used and the jet nozzle can be adjusted toward the upper side of the solid target head to obtain better cooling.

### CONCLUSION

Based on the obtained yields, the described compact solid target for traditional target side works as effectively as a beamline solid target. A water cooled energy degrading front foil may cause lower yield and is dependent on how much energy is needed to reduce and the size of the target area that is exposed to particle beam.

Compared to plated target plate post bombardment and trials, the provided compact target show higher beam current can be achieved on target. Further, the designated Helium cooling jet plays an important role of cooling down low thermoconductive target materials like Yttrium and ¹²⁴TeO₂.

The provided compact solid target can achieve higher current on low thermo conductive target materials compared to the targets on beamline due to the presence of Helium cooling. Two helium jets (see FIG. 3) with adjustable copper tubing that directly cool the target surface is a difference between the provided compact target and conventional targets.

The Helium jet is about 120° apart from where it shoots toward target. Only 2 jets indirectly reach target surface. The third jet is blocked by the target bottom. It is shown that the 2 jets are not aimed at the center of the target and the jets too far away from the surface are at least an inch away. Cooling jet becomes cool gas around the target. This is not effective cooling. It is noted that this beamline target station is designed for flat traditional targets and not for slanted targets.

1. A solid target head for use in a compact cyclotron, the solid target head comprising:
an elongated enclosure, the enclosure being insertable and removable from a solid target chamber, wherein the elongated enclosure has a proximal end and a distal end, the elongated enclosure having a cooling channel extending therethrough, the proximal end having an entry opening and an exit opening for a liquid coolant to flow through the cooling channel.

2. The solid target head of claim 1, wherein the compact cyclotron comprises a medical cyclotron which facilitates a production of radionuclides utilizable in a medical imaging system.

3. The solid target head of claim 1, wherein the elongated enclosure has (i) an outer diameter that is within a range of from about 1.5 to about 3 inches, and (ii) a length that is within the range from about 2 to about 3 inches facilitating a secure insertion of a foil held at a fixed angle with respect to a beam.

4. The solid target head of claim 1, wherein the distal end of the elongated enclosure is sized and shaped to (i) provide a seal having the solid target chamber, and (ii) facilitate a slidable insertion and a removal of the solid target head from the solid target chamber.

5. The solid target head of claim 1, wherein the fixed angle is slanted from about 10 to about 20 degrees with respect to a beam.

6. The solid target head of claim 1, wherein the solid target head is removable from the solid target chamber by an application of pressure via the liquid coolant flowing through the cooling channel.

7. A solid target chamber comprising:
(i) a target chamber configured to releasably secure a solid target head comprising an elongated enclosure that is insertable and removable from the solid target chamber, wherein the elongated enclosure has a proximal end and a distal end, the elongated enclosure having a cooling channel extending therethrough, the proximal end having an entry opening and an exit opening for a liquid coolant to flow through the cooling channel, and
(ii) a target cooling adapter configured for mounting a vacuum separation foil, a liquid line input and output, a gas coolant input and a gas coolant output.

8. The solid target chamber of claim 7, wherein the target chamber and the target cooling adapter form a configuration that has (i) an outer diameter within a range from about 2.5 inches to about-4 inches, and (ii) a length within a range from about 3 inches to about 4 inches.

9-10. (canceled)

11. The solid target chamber of claim 7 further comprising a vacuum adapter provided to effectuate the beam to travel there through from a cyclotron into the solid target head.

12. The solid target chamber of claim 11, wherein a size of the vacuum adapter depends on the cyclotron.

13. A compact solid target comprising:
(i) a solid target chamber; and
(ii) a solid target head solid target head comprising an elongated enclosure that is insertable and removable from the solid target chamber, wherein the elongated enclosure has a proximal end and a distal end, the elongated enclosure having a cooling channel extending therethrough, the proximal end having an entry opening and an exit opening for a liquid coolant to flow through the cooling channel,
wherein the target chamber is configured to releasably secure the solid target head.
